(19) United States
(12) Patent Application Publication
(10) Pub. No.: US 2005/0200596 A1
(43) Pub. Date: Sep. 15, 2005

(54) Foldable user input device

(75) Inventor: Pekka Pihlaja, Helsinki (FI)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(73) Assignee: Nokia Corporation

(21) Appl. No.: 10/801,980

(22) Filed: Mar. 15, 2004

(51) Int. Cl. G09G 5/00; G09G 5/08

(52) U.S. Cl. 345/156

(57) ABSTRACT

A user input device for electronic devices particularly hand held, pocket sized portable electronic devices and mobile cellular telephones is disclosed. The user input device includes an elongated element that nests within a recess in the surface of the electronic device and has a size and shape conforming to the surface contour to form a part of the surface in the region of the recess. The elongated element in a second configuration extends from the surface of the electronic device wherein the user input device is operable as a joystick.

### TECHNICAL FIELD

The present invention relates generally to user input devices for electronic devices and deals more particularly with foldable user input devices operable as a joystick for portable electronic devices such as mobile cellular telephones with gaming capabilities.

### BACKGROUND OF THE INVENTION

It is well-known to use a joystick as a user input device for controlling the movement of action figures and objects for example in arcade games, home gaming systems, gaming electronic devices, personal computers and radio control systems. Joysticks provide good user input control and sensitivity and typically the longer the length of the joystick shaft, the better the control and sensitivity obtainable. One example of such a longer length joystick are the thumb operated joysticks utilized on radio devices for R/C (radio controlled) scale models, for example, R/C helicopters that require very precise, highly sensitive and delicate control to operate and navigate the helicopter. A further advantage of longer length joysticks is that the user can change the way the joystick is held for example with the thumb or between the thumb and the index finger, which variations in holding positions aides in reducing fatigue during long games and operation. Although such longer length joysticks provide good user input control and sensitivity, the presence of a long joystick is undesirable because it adds to the thickness of the portable electronic device increasing it size and changing its shape such that the portable electronic device cannot easily fit into a pocket.

Currently, in portable electronic devices such as cellular mobile telephones, the mobile telephone keypad is used as the user input device when playing a game. The use of the keypad provides less control and sensitivity than a joystick. Another approach to provide a user input device for a game controller in portable electronic devices, such as cellular mobile telephones, is the use of a flat button-like actuator input device that is also used as a navigation device for movement of a cursor or menu selection for example in an X-Y coordinate controlled movement on the screen display of the device. However, such flat button-like actuators provide less control and sensitivity than a joystick. In addition, such button actuators are not analog and typically provide only discrete movement control corresponding to for example, a limited number of compass points.

PCT Application No. PCT/GB2003/004978, the disclosure of which is incorporated herein by reference, is assigned to the same assignee as the present application and discloses an attempt to integrate a joystick into a portable electronic device to obtain greater control and sensitivity during game play. The disclosed user input device has an extendable support which is retracted in a first configuration and extended a small distance in a second configuration wherein the user input device is operable as a joystick. Of necessity, the length of the extendable support is limited to avoid increasing the size of the portable electronic device or making the shape irregular and awkward such that it no longer may for example easily fit in a pocket. A further disadvantage of the user input device disclosed in the PCT application is the joystick is not analog and only provides a limited number of discrete control movements.

It would be desirable, therefore, to integrate a joystick having a greater length into a portable electronic device to obtain greater control and sensitivity during game play. It is further desirable to integrate a joystick having a greater length into a portable electronic device without increasing the size and complexity of the device and further wherein the integrated joystick would not change the shape of the portable electronic device such that it is handheld and easily fits in a pocket. It is further desirable to provide an integrated joystick that provides analog control for game play.

### SUMMARY OF THE INVENTION

In accordance with a first embodiment of the invention, a portable electronic device is presented and includes a user input device. The user input device comprises an elongated element having a first end and a second end disposed opposite the first end, wherein the user input device has a first configuration in which the elongated element is nested within a recess defined in the surface of the portable electronic device. The elongated element has a size and shape conforming to the surface contour of the portable electronic device whereby the elongated element forms a part of the surface of the portable electronic device in the region of the recess. The user input device has a second configuration in which the elongated element is in an extended orientation with respect to the surface of the portable electronic device wherein in the second configuration the user input device is operable as a joystick.

In one aspect of the invention, the elongated element is hingedly connected at its second end for pivotal movement about the hinge axis wherein the elongated element is folded about the hinge axis in the first configuration and unfolded about the hinge axis in the second configuration.

In a further aspect of the invention, the recess is defined in the surface of a navigational device carried on the portable electronic device.

In yet a further aspect of the invention, the elongated element is mounted at its second end for pivotal movement wherein pivotal movement of the user input device is restricted in the first configuration and the user device pivots freely in the second configuration.

In another aspect of the invention, the portable electronic device is pocket sized and for handheld usage.

In still a further aspect of the invention, the portable electronic device is operable as a mobile cellular telephone.

In an even further aspect of the invention, the user input device is arranged to operate as an analog user input device.

In accordance with a second embodiment of the invention, a user input device for a portable electronic device is presented. The user input device comprises an elongated element having a first end and a second end disposed opposite the first end, wherein the user input device has a first configuration in which the elongated element is nested within a recess defined in the surface of the portable electronic device. The user input device has a size and shape conforming to the surface contour of the portable electronic device whereby the elongated element forms a part of the surface of the portable electronic device in the region of the recess. The user input device has a second configuration in which the elongated element is in an extended orientation with respect to the surface of the portable electronic device wherein in the second configuration the user input device is operable as a joystick.

In accordance with a third embodiment of the invention, an electronic device is presented wherein a user input device comprises an elongated element having a first end and a second end disposed opposite the first end. The user input device has a first configuration in which the elongated element is nested within a recess defined in the surface of the portable electronic device in a restricted inoperative position. The elongated element has a size and shape conforming to the surface contour of the portable electronic device whereby the elongated element forms a part of the surface of the portable electronic device in the region of the recess. The user input device has a second configuration in which the elongated element is in an extended operative orientation with respect to the surface of the portable electronic device wherein in the second configuration the user input device is operable as a joystick.

In one aspect of the invention, the electronic device includes means for unfolding the elongated element to its extended orientation in response to a first user action and for folding the elongated element to its nested position in response to a reversal of the first user action.

In a further aspect of the invention, the elongated element is hingedly connected at its second end for pivotal movement about the hinge axis wherein the elongated element is unfolded about the hinge axis to its extended operative orientation and folded about the hinge axis to its nested inoperative orientation.

In another aspect of the invention, the electronic device is pocket sized and for handheld use.

In yet a further aspect of the invention, the user input device is arranged to operate as an analog user input device.

In still a further aspect of the invention, the electronic device is operable as a mobile cellular telephone.

In an even further aspect of the invention, the electronic device is operable as a gaming device.

In accordance with a fourth embodiment of the invention, a user input device for an electronic device is presented and comprises an elongated element having a first end and a second end disposed opposite the first end wherein the user input device has a first configuration in which the elongated element is folded into a recess defined in the surface of the electronic device whereby the elongated element forms a part of the surface of the portable electronic device in the region of the recess, and a second configuration in which the elongated element is in an unfolded extended orientation with respect to the surface of the electronic device wherein in the second configuration the user input device is operable as a joystick.

The term “joystick” as used herein refers to an analog game controller that has a stick-like actuator. The term “gaming device” includes an electronic device that may be used to play games, a multi-functional electronic device that may be used to play games as one of its functions and also, an electronic device that is dedicated to playing games. Although the user input device of the present invention is particularly applicable to gaming devices, its potential application is broader and may be used with any electronic device that requires a user input device.

### BRIEF DESCRIPTION OF THE DRAWINGS

FIG. 1 is a schematic perspective exterior view of a portable electronic device usable as a gaming unit and a mobile cellular telephone with which the foldable user input device embodying the present invention may be utilized;

FIG. 2A is a schematic perspective exterior view of the portable electronic device of FIG. 1 showing the foldable user input device embodying the invention in its first configuration;

FIG. 2B is a schematic perspective exterior view of the portable electronic device of FIG. 1 showing the foldable user input device embodying the invention in its second configuration operable as a joystick;

FIG. 3 is a schematic perspective exterior view of the portable electronic device of FIG. 1 illustrating the foldable user input device embodying the present invention as part of the exterior surface of the navigation button carried on the portable electronic device;

FIG. 4A is a schematic perspective exterior view of the portable electronic device of FIG. 1 illustrating the foldable user input device in an alternate embodiment of the present invention in its first configuration as part of the navigation button carried on the portable electronic device;

FIG. 4B illustrates the elongated element of the user input device shown in FIG. 4A pulled out of the navigation button and staged for movement to the user input device second configuration;

FIG. 4C is a perspective exterior view of the portable electronic device of FIG. 4A illustrating the user input device in its second configuration;

FIG. 5A is a schematic illustration of a portable electronic device wherein a first part is folded in a closed configuration with a second part and is arranged for pivotal and rotational movement with respect to the second part in an unfolded open configuration in which the first part functions as the user input device embodying the invention;

FIG. 5B is a schematic illustration of the portable electronic device of FIG. 5A in an unfolded open configuration wherein the first part in its second configuration functions as the user input device embodying the present invention and is operable as a joystick;

FIG. 6 is a schematic illustration of major functional blocks of a portable electronic device having a user input device embodying the present invention.

### DETAILED DESCRIPTION OF THE INVENTION

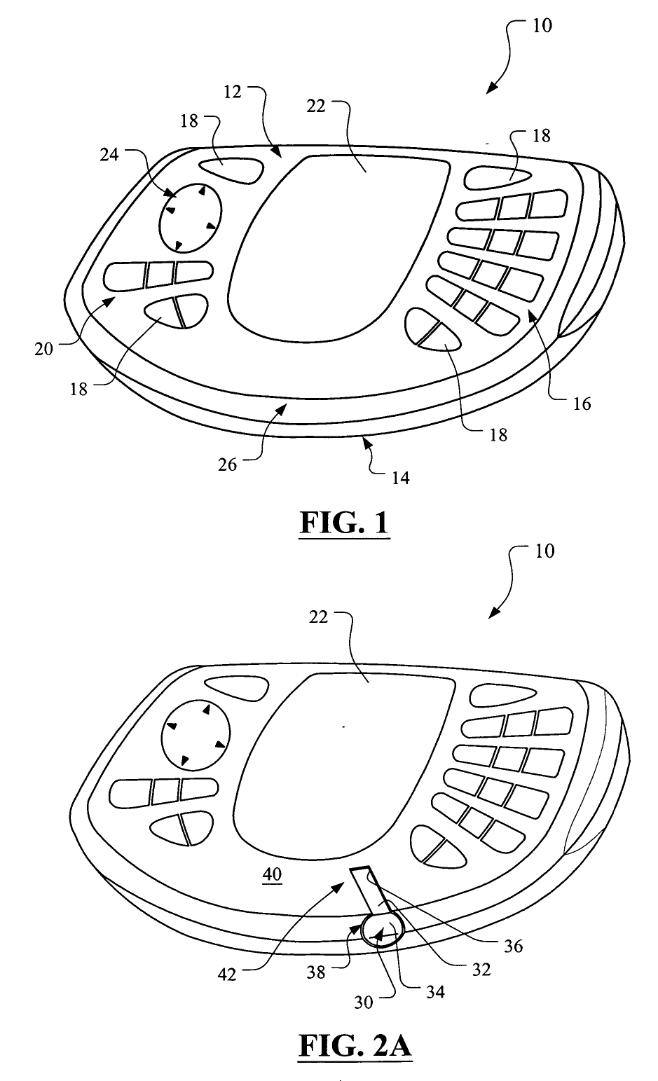

Turning now to the drawing figures wherein like reference numbers refer to like parts, and considering an illustrative, a portable electronic device usable as a gaming unit and a mobile cellular telephone with which the foldable user input device embodying the present invention may be utilized is shown in FIG. 1 in a schematic perspective exterior view and generally designated 10. The portable electronic device 10 is a handheld, pocket sized combination electronic gaming device and mobile cellular telephone and includes an upper surface 12 and a lower surface 14 relative to usage. The portable electronic device 10 includes a keypad 16 having a key assembly array consistent with the intended usage and keys 18, 20 for controlling and selecting the desired operational features and operational functions of the device 10. A screen 22 is carried on the upper surface 12 to provide a visible display of information, graphics and other indicia corresponding to the operative mode of the device 10 as is well-known to those skilled in the art. The device 10 also includes a navigation button generally designated 24 which is utilized in the normal manner for selection of the desired features and functions provided on a menu visible on the display screen 22. The navigation button 24 is also utilized in the gaming function mode to control movement consistent with the game shown on the display screen 22 in a well-known manner. The device 10 typically includes a case or housing 26 having a desired shape, size and contour for carrying the various components and electronic circuitry to carry out the intended function of the device 10. The device 10 is pocket sized and intended for handheld usage. It will be understood that the portable electronic device 10 may in other implementations be a dedicated gaming device, a combination gaming device, a music player and in other combinations including an embodiment having a mobile cellular telephone.

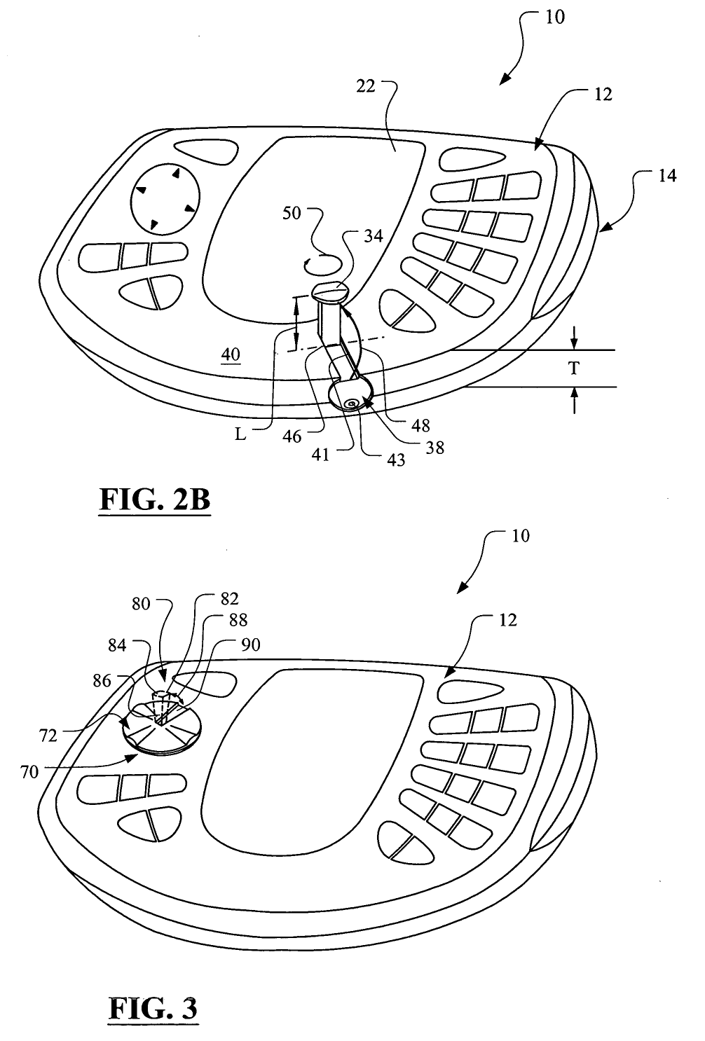

Turning now to FIGS. 2A and 2B, the portable electronic device of FIG. 1 is shown therein, illustrating one embodiment of the foldable user input device embodying the present invention wherein the user input device is designated generally 30. The user input device 30 comprises an elongated element 32 having a first end 34 and a second end 36 disposed generally opposite the first end 34. The user input device 30 has a first configuration as illustrated in FIG. 2A in which the elongated element 32 is nested within a recess 38 defined in the wall portion 41 of the portable electronic device 10. The recess 38 has a size and a shape corresponding generally to the size and shape of the elongated element 32 to receive the user input device 30 in the first configuration. The elongated element 32 is likewise sized and shaped to conform to the exterior surface of the portable electronic device 10 whereby the elongated element 32 forms a part of the surface 40 in the region 42 of the recess 38. The elongated element 32 is hingedly connected at its second end 36 for pivotal movement about the hinge access 46 as indicated by the direction arrow 48 whereby the elongated element 32 is folded about the hinge access 46 in the first configuration. The elongated element 32 is unfolded about the hinge access 46 to a second configuration in which the elongated element 32 is in an extended orientation or position with respect to the surface 40 of the portable electronic device 10 wherein in the second configuration the user input device 30 is operable as a joystick. The elongated element 32 is further mounted at its second end 36 whereby in the second configuration, the user input device 30 pivots freely over a 360° range as indicated by the direction arrow 50 to operate as a joystick in a well-known manner. In actuality, the first end 34 of the user input device 30 is urged in the desired direction to bend or tilt the elongated element 32 which movement is sensed by suitable electronic circuitry carried in the portable electronic device and responds in a well known manner. The length L of the elongated element 32 is greater than the thickness T defined between the upper surface 12 and the lower surface 14 to provide a longer length joystick than would otherwise be possible without changing the size and configuration of the portable electronic device 10.

The foldable user input device 30 can be arranged for multiple functions, for example, the user input device may be configured as an antenna for the mobile cellular telephone. Additionally, the foldable user input device 30 may be used to cover connectors such as, an ear phone jack 43 mounted in the recess 38 and user accessible when the user input device is in its second configuration.

Turning now to FIG. 3, a schematic perspective exterior view of the portable electronic device shown in FIG. 1 is illustrated therein wherein the user input device embodying the present invention forms a part of the exterior surface 72 of the navigational button 70 carried on the upper surface 12 of the portable electronic device 10. The user input device generally designated 80 includes an elongated element 82 having a first end 84 and a second end 86 disposed generally opposite the first end 84. The elongated element 82 is hingedly connected at the second end 86 and arranged for pivotal movement about the hinge access wherein the elongated element 82 is folded about the hinge axis in the first configuration and nests in a restricted inoperative position within a recess 90 defined in the surface 72 of the navigational button 70. The elongated element 82 has a size and shape conforming to the recess and the contour of the exterior surface 72 of the navigational button 70 and forms a part of the surface in the region of the recess. The elongated element 82 is unfolded about the hinge axis in the direction indicated by arrow 88 to a second configuration in which the elongated element 82 is in an extended orientation with respect to the surface 72 of the navigational button 70 and the exterior surface 12 of the portable electronic device 10 wherein in the second configuration, the foldable user input device 80 is operable as a joystick. In this illustrative embodiment, the elongated element 82 mechanically interconnects with the navigational button 70 such that movement of the user input device 80 causes movement of the navigational button 70 which movement is sensed by suitable electronic circuitry carried within the portable electronic device 10 and responds in a well-known manner in the game play. In this embodiment, the navigational button 70 may be utilized as a flat button on the upper surface 12 of the portable electronic device to provide the game play. In either configuration, the user input device 80 in the first configuration does not change the size, shape or contour of the portable electronic device so that the device is easily pocketable and operable as a handheld device.

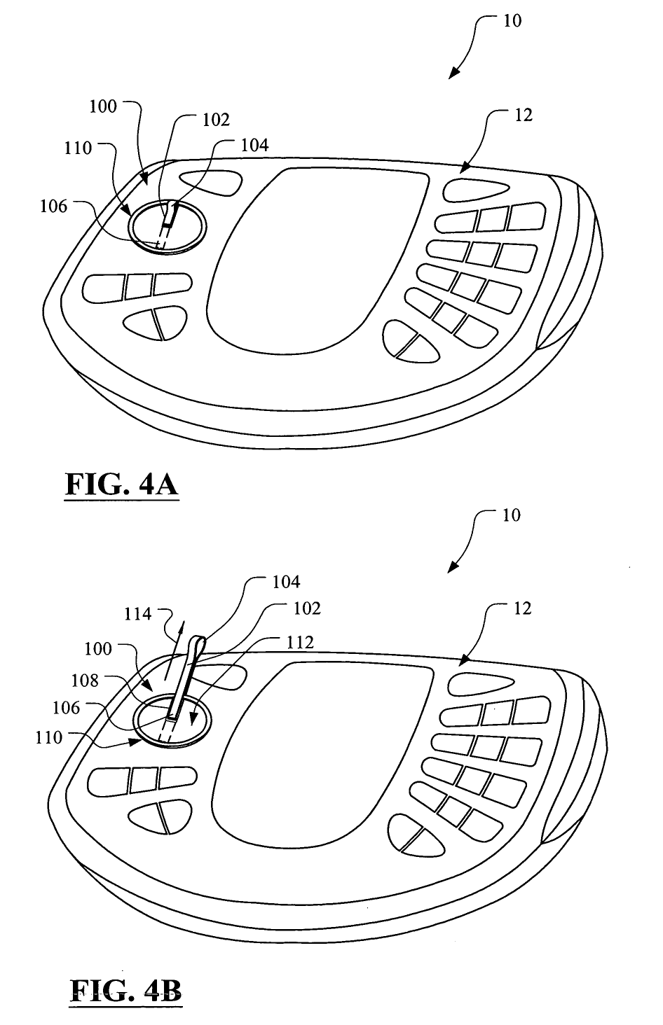

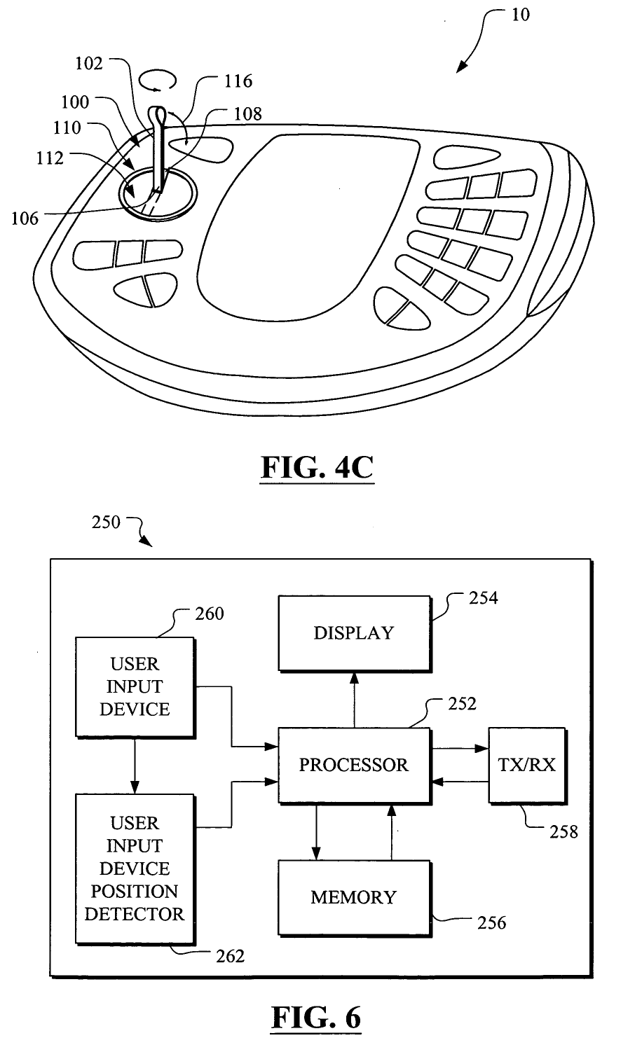

Turning now to FIGS. 4A, 4B and 4C, a schematic perspective exterior view of the portable electronic device illustrated in FIG. 1 is shown therein and generally designated 10 wherein an alternate embodiment of the foldable user input device generally designated 100 is shown as part of the navigational button 110 carried on the upper surface 12 of the portable electronic device 10. In this illustrative embodiment, the user input device 100 includes an elongated element 102 having a first end 104 and second end 106 disposed generally opposite the first end of 104. A recess or slot 108 is defined in the wall surface 112 of the navigational button 110. The user input device 100 has a first configuration in which the elongated element 102 is received within the recess 108 defined in the navigational button whereby the elongated element conforms to the size and shape of the recess 108 and the surface contour of the button 110. In this embodiment, the elongated element 102 is partially pulled or extracted from the button 110 substantially parallel to the surface of the electronic device 10 in the direction indicated by arrow 114. The elongated element 102 is arranged and connected at its second end 106 in a manner which allows the elongated element 102 to unfold in the direction indicated by arrow 116 wherein the user input device 100 is in a second configuration in which the elongated element 102 is in an extended orientation with respect to the surface of the portable electronic device 10 wherein in the second configuration, the user input device is operable as a joystick. In this embodiment, the elongated element 102 is arranged to mechanically lock with the navigational button 110 in a similar manner as described above in connection with FIG. 3. The elongated element 102 may be hingedly connected at its second end 106 or alternately, the elongated element 102 may be rotated into a receiving slot within the navigational button 110 to form the desired mechanical arrangement.

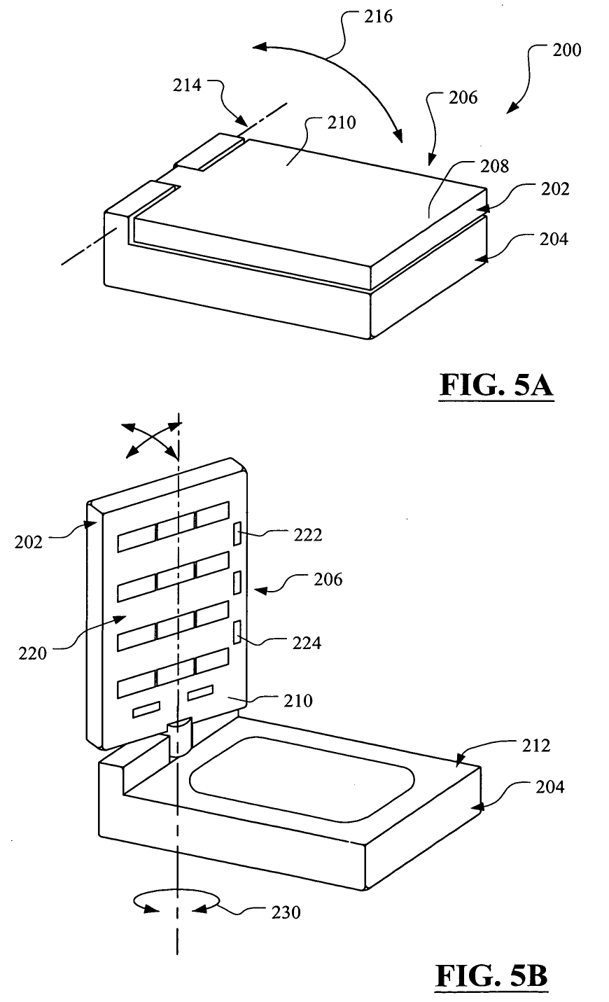

Turning now to FIGS. 5A and 5B, a further alternate embodiment of the foldable user input device embodying the present invention is illustrated therein as a folding mobile cellular telephone generally designated 200. The illustrative mobile cellular telephone 200 has a first part 202 arranged for pivotal and rotational movement with respect to a second part 204. The first part 202 comprises a user input device 206 having a first end 208 and a second end 210 disposed opposite the first end wherein the user input device 206 has a first configuration in which the first part is nested within a recess defined generally in the surface 212 of the second part 204. The first configuration corresponds to the mobile cellular telephone in its carrying state. The first part 202 is arranged for pivotal movement about the hinge axis 214 wherein the first part is folded about the hinge axis in the first configuration and unfolded about the hinge axis in the direction indicated by the direction arrow 216 in the second configuration. In the second configuration, the first part 202 is in an extended orientation with respect to the surface 212 of the mobile cellular telephone. The first part 202 may carry an array of keys 220 consistent with the intended function wherein the keys 222, 224 are arranged for comfortable gripping and operation by the hand of a user in the game play. The first part 202 is arranged at its second end 210 for pivotal movement with respect to the surface 212 of the second part 204 whereby the first part pivots freely in the second configuration as indicated by the direction arrow 230. In actuality, the first part 202 is urged in the desired direction to bend or tilt the first part 202 wherein appropriate electronic circuitry carried within the cellular telephone senses the movement of the first part 202 whereby the user input device 206 is operable as a joystick.

Turning now to FIG. 6, a schematic representation of the major functional blocks of a portable electronic device 250 having a user input device embodying the present invention is illustrated therein and comprises a processor 252 connected to a display 254, a memory 256, a cellular radio transceiver 258, a user input device 260 and a user input device position detector 262. The processor 252 controls the operation of the electronic device 250. The processor 252 receives input command signals from the user input device 260 and the user input device position detector 262 to carry out the intended operation. It will be understood that the arrangement of the functional components of the electronic device 250 as illustrated in FIG. 6 is not limiting and any suitable arrangement may be utilized to carry out the intended function. For example, in some implementations the electronic device 250 may have multiple processors and/or memories and additional components for audio input and output and alternate user input devices such as a keypad. Accordingly, the implementation of the portable electronic device 250 illustrated in FIG. 6 is presented by way of example rather than by limitation.

1. A portable electronic device comprising:
a user input device comprising an elongated element having a first end and a second end disposed opposite said first end, wherein the user input device has a first configuration in which the elongated element is nested within a recess defined in the surface of the portable electronic device and having a size and shape conforming to the surface contour of the portable electronic device whereby the elongated element forms a part of the surface of the portable electronic device in the region of the recess, and a second configuration in which the elongated element is in an extended position with respect to the surface of the portable electronic device wherein in the second configuration the user input device is operable as a joystick.

2. The portable electronic device as defined in claim 1 wherein said elongated element is hingedly connected at its second end for pivotal movement about the hinge axis wherein said elongated element is folded about the hinge axis in said first configuration and unfolded about the hinge axis in said second configuration.

3. The portable electronic device as defined in claim 2 wherein said recess is defined in the surface of a navigational device carried on the portable electronic device.

4. The portable electronic device as defined in claim 1 wherein the user input device is arranged to operate as an analog user input device.

5. The portable electronic device as defined in claim 1 that is pocket sized and for handheld usage.

6. The portable electronic device as defined in claim 2 wherein said elongated element is mounted at its second end for pivotal movement wherein pivotal movement of the user input device is restricted in the first configuration and the user device pivots freely in the second configuration.

7. The portable electronic device as defined in claim 1 that is operable as a mobile cellular telephone.

8. A user input device for a portable electronic device as defined in claim 1.

9. A user input device for a portable electronic device, comprising:
an elongated element having a first end and a second end disposed opposite said first end, wherein the user input device has a first configuration in which the elongated element is nested within a recess defined in the surface of the portable electronic device and having a size and shape conforming to the surface contour of the portable electronic device whereby the elongated element forms a part of the surface of the portable electronic device in the region of the recess, and a second configuration in which the elongated element is in an extended orientation with respect to the surface of the portable electronic device wherein in the second configuration the user input device is operable as a joystick.

10. An electronic device, comprising:
a user input device comprising an elongated element having a first end and a second end disposed opposite said first end, wherein the user input device has a first configuration in which the elongated element is nested within a recess defined in the surface of the portable electronic device in a restricted inoperative position, said elongated element having a size and shape conforming to the surface contour of the portable electronic device whereby the elongated element forms a part of the surface of the portable electronic device in the region of the recess, and a second configuration in which the elongated element is in an extended operative orientation with respect to the surface of the portable electronic device wherein in the second configuration the user input device is operable as a joystick.

11. The electronic device as defined in claim 10 comprising means for unfolding the elongated element to its extended orientation in response to a first user action and for folding the elongated element to its nested position in response to a reversal of the first user action.

12. The electronic device as defined in claim 11 wherein said elongated element is hingedly connected at its second end for pivotal movement about the hinge axis wherein said elongated element is unfolded about the hinge axis to its extended operative orientation and folded about the hinge axis to its nested inoperative position.

13. The electronic device as defined in claim 8 that is pocket sized and for handheld usage.

14. The electronic device as defined in claim 13 that is operable as a mobile cellular telephone.

15. The electronic device as defined in claim 10 that is operable as a gaming device.

16. A user input device for an electronic device as defined in claim 10.

17. A user input device for an electronic device, comprising:
an elongated element having a first end and a second end disposed opposite said first end, wherein the user input device has a first configuration in which the elongated element is folded into a recess defined in the surface of the electronic device whereby the elongated element forms a part of the surface of the portable electronic device in the region of the recess, and a second configuration in which the elongated element is in an unfolded extended orientation with respect to the surface of the electronic device wherein in the second configuration the user input device is operable as a joystick.
